(19) United States
(12) Patent Application Publication
(10) Pub. No.: US 2026/0156389 A1
(43) Pub. Date: Jun. 4, 2026

(54) SYSTEM, METHOD AND COMPUTER-READABLE MEDIUM FOR CONTROLLING WAVELENGTH SWITCHING OF OPEN ALL-PHOTONIC NETWORK

(71) Applicant: CHUNGHWA TELECOM CO., LTD., Taoyuan City (TW)

(72) Inventors: Li-Hsuan Chu, Taoyuan City (TW); Yen-Lin Tung, Taoyuan City (TW); Yong-Zen Huang, Taoyuan City (TW)

(21) Appl. No.: 19/083,510

(22) Filed: Mar. 19, 2025

(30) Foreign Application Priority Data
Nov. 29, 2024 (TW) 113146336

(51) Int. Cl. H04Q 11/00

(52) U.S. Cl. CPC H04Q 11/0005; H04Q 11/0062; H04Q 2011/0018; H04Q 2011/0024; H04Q 2011/0081

(57) ABSTRACT

A system and a method for controlling wavelength switching of open all-photonic network are provided and applied to an open all-photonic network and have wavelength switching protection and recovery functions to ensure that the network can quickly recover and provide reliable services when a failure occurs. During actual operation, information and data of the switching status can be collected in real time by a dynamic route monitoring module, and the configuration of an open all-photonic network transceiver, i.e., wavelength path switching, can be updated by a dynamic configuration module, so that efficient monitoring and management of quality assurance can be provided. A computer-readable medium for executing the method for controlling wavelength switching of open all-photonic network is also provided.

### CROSS-REFERENCE TO RELATED APPLICATION

This application claims the benefit of Taiwan Patent Application Serial No. 113146336 filed on Nov. 29, 2024, the entirety of which is incorporated herein by reference.

### BACKGROUND

### 1. Technical Field

The present disclosure relates to network transmission technology, and more particularly, to a system, a method and a computer-readable medium for controlling wavelength switching of an open all-photonic network.

### 2. Description of Related Art

As the demand for high-speed and low-latency communications continues to increase, traditional transmission networks can no longer meet the requirements of modern data transmission, especially in application scenarios such as big data, the Internet of Things and high-definition video. To solve this problem, the all-photonic network architecture of the open all-photonics network (Open APN) is currently being introduced to support high-speed and low-latency communications.

The innovative optical and wireless network global forum (IOWN GF) proposed a new concept, that is, using the open all-photonic network (Open APN) to achieve technologies such as ultra-low power consumption and ultra-high-speed signal processing that surpass 5G communications. Open APN directly processes the transmission and exchange of signals in the optical domain, bringing great potential for the development of future communication technology. In order to realize Open APN, the architecture of the traditional optical transport network (OTN) is gradually evolving into an open architecture. Specifically, all-photonic transport network of the open architecture, namely the Open APN, decomposes the traditional OTN equipment into three units according to functions of the Open APN: an Open APN interchange (APN-I), an Open APN gateway (APN-G) and an Open APN transceiver (APN-T), wherein the open APN gateway (APN-G) and the open APN interchange (APN-I) are managed by an APN controller (APN-C).

The open all-photonic network (Open APN) architecture partially deconstructs the traditional optical transport network architecture and can support equipment from different manufacturers, thereby reducing the problem of vendor lock-in. However, since each brand of equipment usually has unique functions, it is impossible to use wavelength switched optical network (WSON) technology in the Open APN environment. The wavelength switched optical network (WSON) technology refers to the use of wavelength division multiplexing (WDM) technology to simultaneously transmit data of multiple wavelengths in an optical fiber. When an optical path fails, WSON can quickly switch to other available optical paths to ensure communication connectivity and reliability. In other words, different brands of equipment make it impossible to use wavelength switched optical network (WSON) technology in the Open APN environment. Therefore, when an optical path fails, it may not be possible to switch to other optical paths in real time, thereby affecting network performance and reliability.

Therefore, how to find a network transmission technology, especially how to switch optical paths in real time when needed in an open all-photonic network (Open APN) architecture, has become a goal that persons skilled in the art are eager to pursue.

### SUMMARY

In order to achieve the above-mentioned purposes, the present disclosure provides a system for controlling wavelength switching of an open all-photonic network, the system comprises: a dynamic route monitoring module configured for collecting real-time information about an optical network status, so as to capture a path switching data in a routing status to generate switching status information when the dynamic route monitoring module detects that an optical network has changes in the routing status due to a path obstacle; and a dynamic configuration module connected to the dynamic route monitoring module and configured for executing wavelength switching of an open all-photonic network transceiver in the optical network according to pre-stored circuit routing data when receiving the switching status information, so that the open all-photonic network transceiver is switched to a wavelength corresponding to a new or redundant path.

In one embodiment, the dynamic route monitoring module obtains the real-time information on the optical network status from an open all-photonic network interchange and an open all-photonic network gateway or an optical transport network in the optical network via a northbound interface of a software-defined network controller.

In one embodiment, the northbound interface is an optical transport network manager or an all-photonic network controller.

In one embodiment, the dynamic configuration module executes wavelength switched optical network technology via a southbound interface when the open all-photonic network interchange, the open all-photonic network gateway and the open all-photonic network transceiver are of different equipment vendors, so as to switch the open all-photonic network transceiver to a corresponding wavelength.

In one embodiment, the dynamic configuration module determines via telemetry technology that a circuit utilization rate is in an off-peak period after the path obstacle of an original wavelength is eliminated, and initiates a wavelength recovery program to notify the dynamic route monitoring module to switch back to a path of the original wavelength, and at the same time, the open all-photonic network transceiver switches to the original wavelength.

In one embodiment, the dynamic configuration module uses telemetry big data collection technology to clean and annotate big data to achieve telemetry accuracy of the telemetry technology.

The present disclosure further discloses a method for controlling wavelength switching of an open all-photonic network, the method comprises: collecting, by a dynamic route monitoring module, real-time information about an optical network status; capturing a path switching data in a routing status to generate switching status information when the dynamic route monitoring module detects that an optical network has changes in the routing status due to a path obstacle; and executing, by a dynamic configuration module, wavelength switching of an open all-photonic network transceiver in the optical network according to pre-stored circuit routing data when receiving the switching status information, so that the open all-photonic network transceiver is switched to a wavelength corresponding to a new or redundant path.

In the above-mentioned method, the step of collecting, by the dynamic route monitoring module, the real-time information about the optical network status comprises: obtaining, by the dynamic route monitoring module, the real-time information on the optical network status from an open all-photonic network interchange and an open all-photonic network gateway or an optical transport network in the optical network via a northbound interface of a software-defined network controller.

Further, the northbound interface is an optical transport network manager or an all-photonic network controller.

In the above-mentioned method, the step of executing, by the dynamic configuration module, the wavelength switching of the open all-photonic network transceiver in the optical network comprises: executing, by the dynamic configuration module, wavelength switched optical network technology via a southbound interface when the open all-photonic network interchange, the open all-photonic network gateway and the open all-photonic network transceiver are of different equipment vendors, so as to switch the open all-photonic network transceiver to a corresponding wavelength.

In the above-mentioned method, the method further comprises: determining, by the dynamic configuration module, via telemetry technology that a circuit utilization rate is in an off-peak period after the path obstacle of an original wavelength is eliminated, and initiating a wavelength recovery program to notify the dynamic route monitoring module to switch back to a path of the original wavelength, and at the same time, switching the open all-photonic network transceiver to the original wavelength.

In the above-mentioned method, the dynamic configuration module uses telemetry big data collection technology to clean and annotate big data to achieve telemetry accuracy of the telemetry technology.

The present disclosure further discloses a method for controlling wavelength switching of an open all-photonic network, which is executed on a computer or a server, wherein the method comprises: monitoring, by a dynamic route monitoring module, an open all-photonic network and receiving alarms or wavelength switching messages; using, by the dynamic route monitoring module, telemetry technology to detect changes in routing status of the open all-photonic network via a northbound interface of a software-defined network controller to obtain switching status information related to wavelength switching; and switching, by a dynamic configuration module, an open all-photonic network transceiver in the open all-photonic network to a corresponding wavelength in real time according to the switching status information of the dynamic route monitoring module.

In the above-mentioned method, the step of switching the open all-photonic network transceiver in the open all-photonic network to the corresponding wavelength in real time comprises: switching the open all-photonic network transceiver to a wavelength corresponding to a new or redundant path via the dynamic configuration module in real time when an obstacle occurs on a path of an original wavelength, or capturing, by the dynamic configuration module, circuit traffic via a southbound interface when the obstacle on the path of the original wavelength is cleared, so that a wavelength recovery program is initiated when a circuit utilization rate is low and in an off-peak period, so as to notify the dynamic route monitoring module to switch back to the path of the original wavelength, and switch the open all-photonic network transceiver to the original wavelength via the dynamic configuration module in real time.

The present disclosure further discloses a computer-readable medium, used in a computing device or a computer, and stores instructions to execute the above-mentioned methods.

To sum up, a system and a method for controlling wavelength switching of open all-photonic network and a computer-readable medium thereof of the present disclosure are applied to an open all-photonic network and have wavelength switching protection and recovery functions to achieve 1+R protection solution in optical transport network, and to ensure that the network can quickly recover and provide reliable services when a failure occurs. During actual operation, information and data of the switching status can be collected in real time by a dynamic route monitoring module, and the configuration of an open all-photonic network transceiver, i.e., wavelength path switching, can be updated by a dynamic configuration module, so that efficient monitoring and management of quality assurance can be provided.

The aforementioned 1+R protection solution is a mechanism that combines protection and recovery to ensure the stability and reliability of network connections. In the 1+R architecture, “1” represents the main route and “R” represents the recovery route. The main route is the main transmission channel during normal operation. The recovery route is a backup channel that is activated when the main route fails. The 1+R protection solution has fault monitoring and rapid recovery. That is, the system will continuously monitor the operation of the primary path. Once a link failure is detected, the system will automatically switch to the recovery path immediately to ensure uninterrupted service. This rapid recovery capability is one of the core advantages of the 1+R protection solution. Furthermore, the 1+R protection solution provides good resource efficiency. Compared with the traditional 1+1 protection solution, the 1+R protection solution is more efficient in resource utilization. The recovery route is usually not used under normal circumstances to save bandwidth resources.

### BRIEF DESCRIPTION OF THE DRAWINGS

FIG. 1 is a system architecture diagram of a system for controlling wavelength switching of an open all-photonic network according to the present disclosure.

FIG. 2 is an operational architecture diagram of a system for controlling wavelength switching of an open all-photonic network according to a specific embodiment of the present disclosure.

FIG. 3 is a step diagram of a method for controlling wavelength switching of an open all-photonic network according to the present disclosure.

FIG. 4 is a step diagram of a method for controlling wavelength switching of an open all-photonic network according to another embodiment of the present disclosure.

FIG. 5 is an operation flowchart of dynamic wavelength switching during service failure according to the present disclosure.

FIG. 6 is an operation flowchart of dynamic wavelength recovery during service recovery according to the present disclosure.

### DETAILED DESCRIPTION

The following illustrative embodiments are provided to illustrate the present disclosure, these and other advantages and effects can be apparently understood by those skilled in the art after reading the disclosure of this specification. However, the present disclosure can also be implemented or applied through other different specific implementation forms.

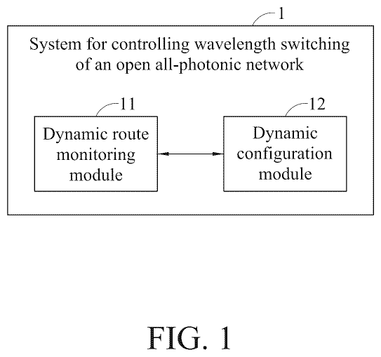

FIG. 1 is a system architecture diagram of a system for controlling wavelength switching of an open all-photonic network according to the present disclosure. Wavelength switched optical network (WSON) technology or function uses wavelength division multiplexing (WDM) technology to transmit data of multiple wavelengths simultaneously in an optical fiber. When an optical path fails, WSON technology or function can quickly switch to other available optical paths to ensure the connectivity and reliability of communications. However, WSON technology or function cannot be used in the open all-photonic network (Open APN) environment because each brand of equipment usually has unique functions. In this regard, the present disclosure proposes a WSON architecture suitable for an open all-photonic network. The present disclosure can realize dynamic wavelength switching under equipment from different manufacturers to ensure the reliability of the network. As shown in FIG. 1, a system 1 for controlling wavelength switching of an open all-photonic network of the present disclosure includes a dynamic route monitoring module 11 and a dynamic configuration module 12.

The dynamic route monitoring module 11 is configured for collecting real-time information about an optical network status, so that path switching data in a routing status is captured to generate switching status information when the dynamic route monitoring module 11 detects that the optical network has changes in the routing status due to a path obstacle. In one embodiment, the dynamic route monitoring module 11 collects and updates real-time information about the optical network status, including real-time routing status and switching records, so as to monitor and manage a network. By continuously monitoring the network status, the dynamic route monitoring module 11 can detect the changes in the routing status and update an infrastructure of the network in real time. In addition, the dynamic route monitoring module 11 must also be able to record the original wavelength information in circuit routing data of the system 1 for controlling wavelength switching of the open all-photonic network, wherein the original wavelength information can be used as a reference when switching wavelengths.

The dynamic configuration module 12 is connected to the dynamic route monitoring module 11. The dynamic configuration module 12 is configured for executing wavelength switching of an open all-photonic network transceiver in the optical network according to pre-stored circuit routing data when receiving the switching status information, so that the open all-photonic network transceiver is switched to a wavelength corresponding to a new or redundant path. In one embodiment, the dynamic configuration module 12 can update a configuration of the open APN transceiver (APN-T) in real time according to the switching status information received from the dynamic route monitoring module 11.

Specifically, the WSON technology or function will switch to a new or redundant path to replace the original path when an original wavelength path is blocked and cannot pass. However, since the open all-photonic network is usually not able to exchange information between equipment in real time due to different equipment vendors, the APN-T in the open all-photonic network cannot be replaced with the corresponding wavelength in real time, and this will cause the optical path to be disconnected. Therefore, when the dynamic configuration module 12 receives the switching status information of the optical path from the dynamic route monitoring module 11, the dynamic configuration module 12 will immediately notify the all-photonic network transceiver (APN-T) to switch to the corresponding wavelength in real time so that the optical path can remain connected. Accordingly, the present disclosure can still possess WSON technology or function under an open all-photonic network architecture.

In one embodiment, the dynamic configuration module 12 uses telemetry big data collection technology to clean and annotate the big data to achieve the telemetry accuracy of the telemetry technology. Specifically, the dynamic configuration module 12 uses telemetry big data collection technology and cleans and annotates the big data to overcome the big data acquisition problem. By reducing the amount of data processing, the dynamic configuration module 12 can support telemetry accuracy at second-level (the term “second” in “second-level” is referred as time). In addition, the traditional approach may detect once in a period of time (e.g., one minute), but this approach may cause switching delays. The present disclosure adopts telemetry big data collection technology, which can obtain data at the second-level (that is, immediately), thereby reducing network instability caused by delays.

In addition, the dynamic configuration module 12 will switch the optical path currently used for transmission back to the original path after the path obstacle of the original wavelength is eliminated, that is, when the dynamic configuration module 12 determines that the circuit utilization rate is low and it is in the off-peak period, it means that the switching action will not cause too much impact, so a wavelength recovery program can be initiated. At this time, the dynamic configuration module 12 notifies the dynamic route monitoring module 11 to switch back to the original wavelength path, and at the same time dynamically configures the open all-photonic network transceiver, so that a service wavelength of the open all-photonic network transceiver is changed back to the original wavelength, that is, the current wavelength path is switched back to the original wavelength path.

In summary, the present disclosure can provide WSON technology or function in an open all-photonic network via dynamic route monitoring and real-time dynamic configuration of the all-photonic network transceiver. Therefore, in actual operation, the dynamic route monitoring module 11 is first used to collect optical path information, and the wavelength path to be switched is obtained by using WSON technology or function. The dynamic configuration module 12 then switches the related open all-photonic network transceiver (APN-T) to the same path wavelength to ensure the reliability of the network.

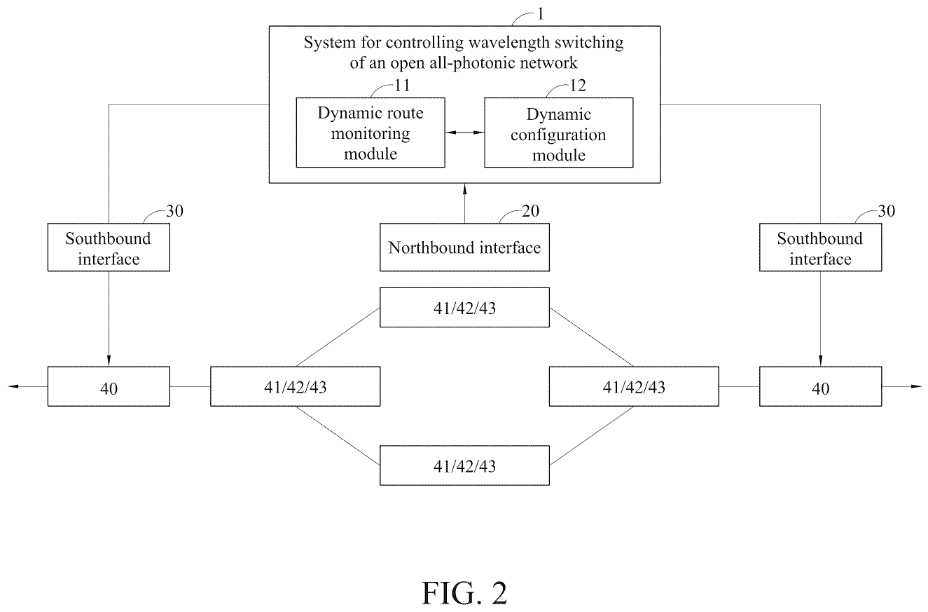

FIG. 2 is an operational architecture diagram of a system for controlling wavelength switching of an open all-photonic network according to a specific embodiment of the present disclosure, the system at least includes: a system 1 for controlling wavelength switching of an open all-photonic network, a northbound interface 20, southbound interfaces 30, APN-T 40, and OTN 41/APN-I 42/APN-G 43. As shown in FIG. 2, the system 1 for controlling wavelength switching of the open all-photonic network is the same as that illustrated in FIG. 1, and thus will not be described in detail. In one embodiment, the system 1 for controlling wavelength switching of the open all-photonic network and the operation architecture of the entire open all-photonic network are further described.

The dynamic route monitoring module 11 obtains real-time information on the optical network status from the open APN interchange (APN-I) and open APN gateway (APN-G) or the optical transport network (OTN) in the optical network via the northbound interface 20 of a software defined network (SDN) controller. In one embodiment, the northbound interface 20 can be an optical transport network manager or an open APN controller (APN-C).

In one embodiment, the dynamic route monitoring module 11 captures real-time information such as key critical alarms, dynamic route switching status and/or dynamic routing with second-level accuracy via an open interface of the software-defined network (SDN) controller (such as transport application programming interface [T-API] and telemanagement forum API [TMF-API]), thereby obtaining real-time information on the optical network status.

When the open all-photonic network interchange (APN-I), the open all-photonic network gateway (APN-G) and the open all-photonic network transceiver (APN-T) are of different equipment vendors, the dynamic configuration module 12 can execute the wavelength switched optical network (WSON) technology or function via the southbound interfaces 30 to enable the open all-photonic network transceiver (APN-T) to switch to the corresponding wavelength. In one embodiment, when the open all-photonic network interchange (APN-I)/open all-photonic network gateway (APN-G)/optical transport network (OTN) and the open all-photonic network transceiver (APN-T) come from different equipment vendors, WSON intercommunication will be performed via an open interface (such as OpenConfig).

Specifically, the dynamic configuration module 12 captures real-time information such as key critical optical power, optical signal-to-noise ratio (OSNR), calibration operation, central processing unit (CPU) usage, memory usage and/or power consumption with second-level accuracy via an open interface (such as OpenConfig), thereby obtaining real-time information on the open all-photonic network transceiver (APN-T).

In addition, if the obstacle of the original wavelength path has been eliminated and the circuit utilization rate is determined to be in the off-peak period according to the statistics via telemetry technology, the wavelength recovery program can be initiated. The dynamic configuration module 12 may notify the dynamic route monitoring module 11 to switch back to the original wavelength path first.

As can be seen from the above, the system 1 for controlling wavelength switching of an open all-photonic network of the present disclosure can monitor APN-I/APN-G/OTN via a northbound interface, such as APN-C (using REST/T-API, where REST stands for representational state transfer) or an OTN manager (using CORBA/TMF-API, where CORBA stands for common object request broker architecture), and manage APN-T via a southbound interface (such as an application using NETCONF/YANG, where NETCONF stands for network configuration and YANG stands for yet another next generation), thereby meeting the requirements for low latency and stable network. The system is a WSON technology or functional architecture suitable for the open all-photonic network (Open APN), and can realize dynamic wavelength switching under different manufacturers' equipment to ensure the reliability of the network. This architecture allows wavelength switching between different providers, thereby not only providing high-speed, reliable and low-latency connections, but also providing customers with a high-quality experience and significantly reduces maintenance costs.

Each module of the present disclosure can be software, hardware, or firmware; if the module is hardware, it can be a processing unit, a processor, a computer, or a server with data processing and computing capabilities; if the module is software or firmware, it may include instructions executable by a processing unit, a processor, a computer, or a server, and may be installed on the same hardware device or distributed on multiple different hardware devices.

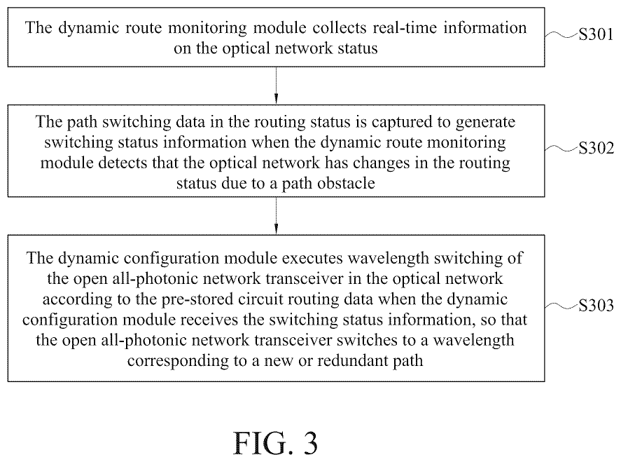

FIG. 3 is a step diagram of a method for controlling wavelength switching of an open all-photonic network according to the present disclosure. As shown in FIG. 3, the method of controlling wavelength switching of an open all-photonic network of the present disclosure can be executed on a computer or a server, and the purpose is to achieve real-time wavelength switching in the open all-photonic network, thereby ensuring the quality of network transmission.

In step S301, the dynamic route monitoring module collects real-time information on the optical network status. Step S301 explains that the dynamic route monitoring module collects and updates real-time information about the optical path, such as real-time routing status and switching records, so as to monitor and manage the network.

In one embodiment, the step of collecting real-time information about the optical network status by the dynamic route monitoring module further comprises that: the dynamic route monitoring module obtains real-time information on the optical network status from the open all-photonic network interchange and the open all-photonic network gateway or the optical transport network (OTN) in the optical network via the northbound interface of the software-defined network (SDN) controller. In one embodiment, the dynamic route monitoring module captures real-time information such as key critical alarms, dynamic route switching status, dynamic routing and/or optical power with second-level accuracy via the open interface of the SDN controller (such as T-API and TMF-API), and the open interface of the SDN controller can be an optical transport network manager or an all-photonic network controller.

In step S302, the path switching data in the routing status is captured to generate switching status information when the dynamic route monitoring module detects that the optical network has changes in the routing status due to a path obstacle. Step S302 describes that the dynamic route monitoring module obtains the path switching data from the routing status to generate switching status information when the dynamic route monitoring module detects a change in routing status, wherein this switching status information will be used for the configuration of subsequent infrastructure (such as the open all-photonic network transceiver).

In step S303, the dynamic configuration module executes wavelength switching of the open all-photonic network transceiver in the optical network according to the pre-stored circuit routing data when the dynamic configuration module receives the switching status information, so that the open all-photonic network transceiver switches to a wavelength corresponding to a new or redundant path. Step S303 describes that the dynamic configuration module receives the switching status information and what wavelength of the new or redundant path is obtained from the circuit routing data, thereby configuring the open all-photonic network transceiver to switch to the corresponding wavelength.

In one embodiment, the step of performing wavelength switching of an open all-photonic network transceiver in an optical network further comprises that: when an open all-photonic network interchange (APN-I), an open all-photonic network gateway (APN-G) and an open all-photonic network transceiver (APN-T) are from different equipment vendors, a dynamic configuration module executes a wavelength switched optical network (WSON) technology or function via a southbound interface to enable the open all-photonic network transceiver to switch to a corresponding wavelength.

In one embodiment, since the above-mentioned equipment are from different manufacturers and cannot communicate directly, the dynamic configuration module executes the wavelength switched optical network (WSON) technology or function via the southbound interface after the dynamic configuration module receives the switching status information generated by the dynamic route monitoring module, wherein the southbound interface may be, for example, OpenConfig, thereby updating the configuration of the open all-photonic network transceiver (APN-T) in real time, that is, switching of different wavelength paths.

In other embodiments, the dynamic configuration module can determine the circuit utilization rate via telemetry technology when the path obstacle of the original wavelength is eliminated. When the circuit utilization rate is low and it is off-peak, the wavelength recovery program can be initiated so that the optical path can be restored to the original path. At this time, the dynamic configuration module will notify the dynamic route monitoring module to switch back to the original wavelength path, and simultaneously configure the open all-photonic network transceiver to switch back to the original wavelength path.

In addition, the dynamic configuration module uses telemetry big data collection technology to clean and annotate the big data. In addition to being able to quickly obtain data, the amount of data can be reduced through cleaning and annotating, thereby increasing the accuracy of telemetry technology.

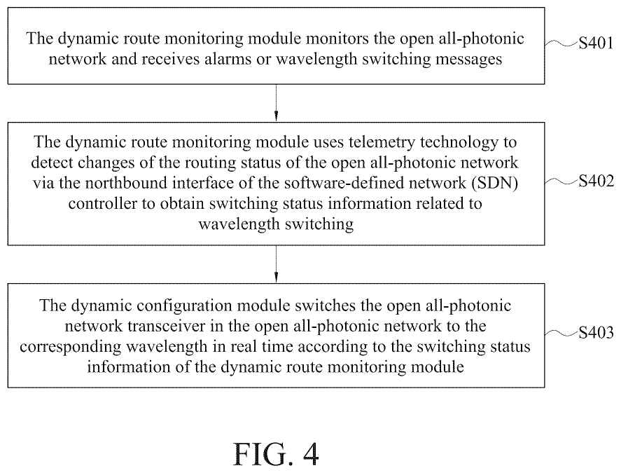

FIG. 4 is a step diagram of a method for controlling wavelength switching of an open all-photonic network according to another embodiment of the present disclosure, wherein, in this embodiment, the wavelength switching method is defined from the perspective of equipment.

In step S401, the dynamic route monitoring module monitors the open all-photonic network and receives alarms or wavelength switching messages. Step S401 shows that the dynamic route monitoring module monitors the network and receives alarms and wavelength switching messages to distinguish whether the service is faulty or restored. If the service is faulty, a different wavelength path will be switched. If the service is restored, a wavelength recovery program will be performed.

Furthermore, WSON technology or function can be used to find a new or redundant wavelength path or the original wavelength path when APN-I/APN-G/OTN are equipment of the same manufacturer. However, if the APN-T is an equipment from a different manufacturer than the above, it is not possible to exchange messages directly, so the technology of the present disclosure must be used to assist in adjusting the configuration.

In step S402, the dynamic route monitoring module uses telemetry technology to detect changes of the routing status of the open all-photonic network via the northbound interface of the software-defined network (SDN) controller to obtain switching status information related to wavelength switching. Step S402 explains that the dynamic route monitoring module uses the telemetry technology of the equipment vendor via the open interface of the SDN controller (such as T-API and TMF-API) to detect changes of the routing status with second-level accuracy and capture real-time information such as wavelength switching. That is, the dynamic route monitoring module obtains route changes in the open all-photonic network via the northbound interface and generates switching status information, and this switching status information will serve as the basis for the configuration of the subsequent infrastructure.

In step S403, the dynamic configuration module switches the open all-photonic network transceiver in the open all-photonic network to the corresponding wavelength in real time according to the switching status information of the dynamic route monitoring module. Step S403 describes how the dynamic configuration module switches the APN-T to the corresponding wavelength via the switching wavelength provided by the dynamic route monitoring module. Step S403 can further include the following two situations.

The first situation is that when an obstacle occurs in the path of the original wavelength, the open all-photonic network transceiver is switched to the wavelength of a new or redundant path in real time via the dynamic configuration module.

In one embodiment, if the original wavelength path is obstructed, it is necessary to switch to a new or redundant wavelength path, and use the dynamic configuration module to switch the APN-T to the corresponding wavelength in real time.

The second situation is that when the obstacle of the original wavelength path is cleared, the dynamic configuration module captures the circuit traffic via the southbound interface. Accordingly, when the circuit utilization rate is low and it is off-peak, the wavelength recovery program is initiated to notify the dynamic route monitoring module to switch back to the original wavelength path, and switch the open all-photonic network transceiver to the original wavelength via the dynamic configuration module in real time.

In one embodiment, if the obstacle of the original wavelength path has been cleared and it is necessary to switch to the original wavelength path, the dynamic configuration module captures the circuit traffic with second-level accuracy via an open interface (i.e., a southbound interface). If the usage rate is very low and it is an off-peak period, the wavelength switching program is initiated, and the dynamic route monitoring module is notified to switch back to the original wavelength path first, and the dynamic configuration module is used to switch the APN-T to the corresponding wavelength in real time.

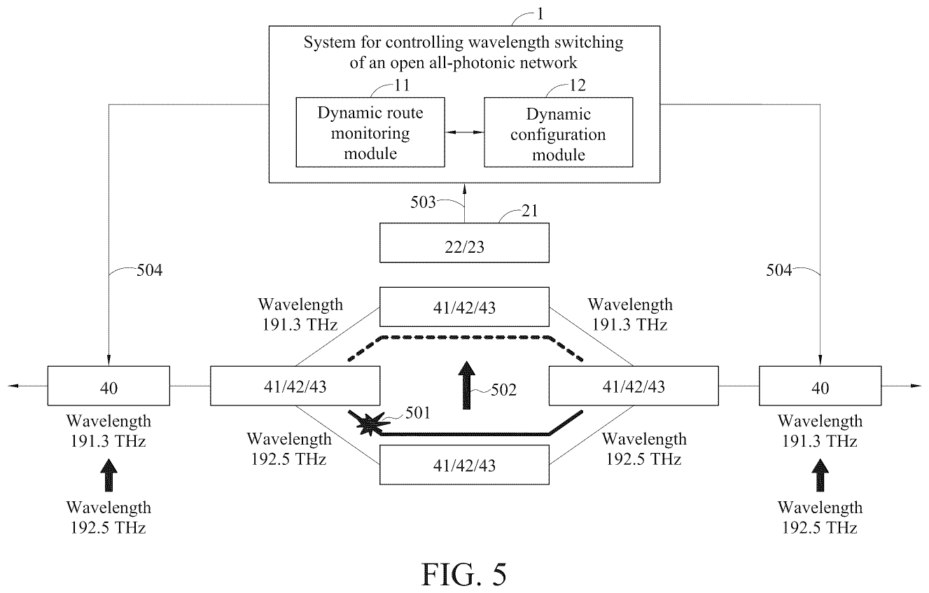

FIG. 5 is an operation flowchart of dynamic wavelength switching during service failure according to the present disclosure, wherein at least the following are included: a system 1 for controlling wavelength switching of an open all-photonic network, APN-T 40, OTN 41/APN-I 42/APN-G 43, OTN manager 22, and APN-C 23.

In process 501, a failure occurs in the original optical path and affects the service circuit.

In process 502, the open all-photonic network interchange (APN-I)/open all-photonic network gateway (APN-G)/optical transport network (OTN) uses WSON technology or function to switch the service to a new path, so that the wavelength path is switched from 192.5 THz (terahertz) to a new/redundant wavelength path of 191.3 THz.

In process 503, an OTN manager/APN-C 21 sends notifications to the dynamic route monitoring module in the system for controlling wavelength switching of the open all-photonic network, including optical path failures, service alarms, dynamic routing status, and switchover details.

In process 504, the system for controlling wavelength switching of the open all-photonic network uses a dynamic configuration module to modify the faulty wavelength path of 192.5 THz to a new/redundant wavelength path of 191.3 THz.

Based on the above, the dynamic switching of wavelengths is completed in real time and the service is restored.

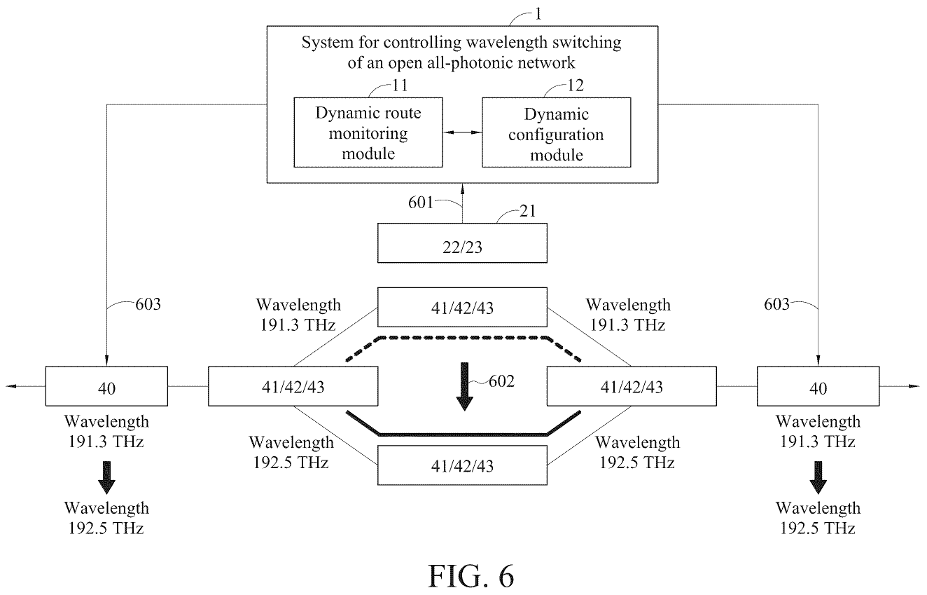

FIG. 6 is an operation flowchart of dynamic wavelength recovery during service recovery according to the present disclosure, wherein at least the following are included: a system 1 for controlling wavelength switching of an open all-photonic network, APN-T 40, OTN 41/APN-I 42/APN-G 43, OTN manager 22, and APN-C 23.

In process 601, when the failed optical path resumes service, multiple clear alarms will be reported to the OTN manager/APN-C 21, indicating that the service has been restored and can be switched. Subsequently, the OTN manager/APN-C 21 sends notifications to the dynamic route monitoring module in the system for controlling wavelength switching of the open all-photonic network, providing information about the restored optical path and restored service.

In process 602, considering that the service will be temporarily interrupted during the switching to the original wavelength path, it is necessary to select an appropriate time for switching. The dynamic configuration module uses telemetry big data collection technology via the southbound interface to clean and annotate the big data, overcome the problem of capturing big data, and capture key critical circuit traffic with second-level accuracy. Furthermore, if the obstacle of the original wavelength path has been eliminated and the circuit utilization rate is determined to be in the off-peak period according to the statistics via telemetry technology, the wavelength recovery program can be initiated to notify the dynamic route monitoring module to switch back to the original wavelength path first. APN-I/APN-G/OTN will switch to the original path (i.e., the original path before the obstacle), that is, the wavelength path is changed from 191.3 THz to 192.5 THz.

In process 603, the system for controlling wavelength switching of the open all-photonic network uses a dynamic configuration module to modify the redundant wavelength path corresponding to 191.3 THz to the original wavelength path corresponding to 192.5 THz.

Based on the above, the dynamic wavelength recovery is completed and the service is restored.

In addition, the present disclosure also discloses a computer-readable medium, which is applied to a computing device or computer having a processor (for example, central processing unit [CPU], graphics processing unit [GPU], etc.) and/or a memory, and stores instructions. Moreover, the computing device or computer can be used to execute the computer-readable medium via the processor and/or memory, so as to execute the above-mentioned method and each step process when executing the computer-readable medium. In one embodiment, the computer-readable medium is a non-transitory computer-readable storage medium.

As can be seen from the above, the system and method for controlling wavelength switching of an open all-photonic network and the computer-readable medium thereof of the present disclosure can be applied to an open all-photonic network and have wavelength switching protection and recovery functions to ensure that the network can be quickly restored and provide reliable services when a failure occurs. During operation, the dynamic route monitoring module collects information and data about the switching status in real time, and the dynamic configuration module updates the configuration of the open all-photonic network transceiver (i.e., wavelength path switching), thereby providing efficient quality assurance monitoring and management. In summary, the present disclosure has the following advantages.

First, high elasticity. Different wavelengths can be dynamically allocated to achieve efficient use of network resources and greater network design flexibility.

Second, resource optimization. By dynamically allocating wavelengths, network resources are optimally configured, thereby ensuring high connection speed and low latency, and improving network performance and reliability.

Third, scalability. The present disclosure can be applied in real network environments and is compatible with equipment and technologies from different vendors.

The above detailed description is a specific description of a feasible embodiment of the present disclosure. However, this embodiment is not intended to limit the patent scope of the present disclosure. Any equivalent implementation or modification that does not depart from the technical spirit of the present disclosure shall be included in the patent scope of the present disclosure.

What is claimed is:

1. A system for controlling wavelength switching of an open all-photonic network, comprising:
a dynamic route monitoring module configured for collecting real-time information about an optical network status, so as to capture a path switching data in a routing status to generate switching status information when the dynamic route monitoring module detects that an optical network has changes in the routing status due to a path obstacle; and
a dynamic configuration module connected to the dynamic route monitoring module and configured for executing wavelength switching of an open all-photonic network transceiver in the optical network according to pre-stored circuit routing data when receiving the switching status information, so that the open all-photonic network transceiver is switched to a wavelength corresponding to a new or redundant path.

2. The system of claim 1, wherein the dynamic route monitoring module obtains the real-time information on the optical network status from an open all-photonic network interchange and an open all-photonic network gateway or an optical transport network in the optical network via a northbound interface of a software-defined network controller.

3. The system of claim 2, wherein the northbound interface is an optical transport network manager or an all-photonic network controller.

4. The system of claim 2, wherein the dynamic configuration module executes wavelength switched optical network technology via a southbound interface when the open all-photonic network interchange, the open all-photonic network gateway and the open all-photonic network transceiver are of different equipment vendors, so as to switch the open all-photonic network transceiver to a corresponding wavelength.

5. The system of claim 1, wherein the dynamic configuration module determines via telemetry technology that a circuit utilization rate is in an off-peak period after the path obstacle of an original wavelength is eliminated, and initiates a wavelength recovery program to notify the dynamic route monitoring module to switch back to a path of the original wavelength, and at the same time, the open all-photonic network transceiver switches to the original wavelength.

6. The system of claim 5, wherein the dynamic configuration module uses telemetry big data collection technology to clean and annotate big data to achieve telemetry accuracy of the telemetry technology.

7. A method for controlling wavelength switching of an open all-photonic network, comprising following steps:
collecting, by a dynamic route monitoring module, real-time information about an optical network status;
capturing a path switching data in a routing status to generate switching status information when the dynamic route monitoring module detects that an optical network has changes in the routing status due to a path obstacle; and
executing, by a dynamic configuration module, wavelength switching of an open all-photonic network transceiver in the optical network according to pre-stored circuit routing data when receiving the switching status information, so that the open all-photonic network transceiver is switched to a wavelength corresponding to a new or redundant path.

8. The method of claim 7, wherein the step of collecting, by the dynamic route monitoring module, the real-time information about the optical network status comprises: obtaining, by the dynamic route monitoring module, the real-time information on the optical network status from an open all-photonic network interchange and an open all-photonic network gateway or an optical transport network in the optical network via a northbound interface of a software-defined network controller.

9. The method of claim 8, wherein the northbound interface is an optical transport network manager or an all-photonic network controller.

10. The method of claim 8, wherein the step of executing, by the dynamic configuration module, the wavelength switching of the open all-photonic network transceiver in the optical network comprises: executing, by the dynamic configuration module, wavelength switched optical network technology via a southbound interface when the open all-photonic network interchange, the open all-photonic network gateway and the open all-photonic network transceiver are of different equipment vendors, so as to switch the open all-photonic network transceiver to a corresponding wavelength.

11. The method of claim 7, further comprising: determining, by the dynamic configuration module, via telemetry technology that a circuit utilization rate is in an off-peak period after the path obstacle of an original wavelength is eliminated, and initiating a wavelength recovery program to notify the dynamic route monitoring module to switch back to a path of the original wavelength, and at the same time, switching the open all-photonic network transceiver to the original wavelength.

12. The method of claim 11, wherein the dynamic configuration module uses telemetry big data collection technology to clean and annotate big data to achieve telemetry accuracy of the telemetry technology.

13. A method for controlling wavelength switching of an open all-photonic network, comprising following steps:
monitoring, by a dynamic route monitoring module, an open all-photonic network and receiving alarms or wavelength switching messages;
using, by the dynamic route monitoring module, telemetry technology to detect changes in routing status of the open all-photonic network via a northbound interface of a software-defined network controller to obtain switching status information related to wavelength switching; and
switching, by a dynamic configuration module, an open all-photonic network transceiver in the open all-photonic network to a corresponding wavelength in real time according to the switching status information of the dynamic route monitoring module.

14. The method of claim 13, wherein the step of switching the open all-photonic network transceiver in the open all-photonic network to the corresponding wavelength in real time comprises: switching the open all-photonic network transceiver to a wavelength corresponding to a new or redundant path via the dynamic configuration module in real time when an obstacle occurs on a path of an original wavelength, or capturing, by the dynamic configuration module, circuit traffic via a southbound interface when the obstacle on the path of the original wavelength is cleared, so that a wavelength recovery program is initiated when a circuit utilization rate is low and in an off-peak period, so as to notify the dynamic route monitoring module to switch back to the path of the original wavelength, and switch the open all-photonic network transceiver to the original wavelength via the dynamic configuration module in real time.
